(19) United States
(12) Patent Application Publication
(10) Pub. No.: US 2002/0124228 A1
(43) Pub. Date: Sep. 5, 2002

(54) Method of and system for manufacturing a semiconductor device

(76) Inventor: Arshad Madni, Swindon (GB)

Correspondence Address: THOMPSON HINE L.L.P., 2000 COURTHOUSE PLAZA , N.E., 10 WEST SECOND STREET, DAYTON, OH, 45402, US

(21) Appl. No.: 10/086,389

(22) Filed: Mar. 1, 2002

(30) Foreign Application Priority Data
Mar. 2, 2001 (GB) 0105184.6

(51) Int. Cl. G06F 17/50

(52) U.S. Cl. 716/1; 716/9; 716/11

(57) ABSTRACT

A method is provided for manufacturing a semiconductor device. A design file is selected from a library and contains a design of a circuit block. A process file containing information about a manufacturing process including performance information about the performance of one or more of the components produced by the manufacturing process is selected from another library. The desired performance specification from the circuit block is defined. Operation of the circuit block is then simulated using the performance information from the process file and the simulation result is compared with the desired performance specification. If the performance specification is achieved, the design is used to manufacture the semiconductor device.

### Field of the Invention

The present invention relates to a method of and system for manufacturing a semiconductor device. For example, the semiconductor device may comprise an integrated circuit or part of an integrated circuit of analog type.

### SUMMARY OF THE INVENTION

According to the invention, there is provided a method of manufacturing a semiconductor device, comprising:

(a) selecting a design file containing a design of an analog circuit block from a first library;

(b) selecting from a second library a process file containing information about a manufacturing process including performance information about the performance of at least one electronic component in the circuit block;

(c) defining a desired performance specification to be achieved by the circuit block;

(d) simulating operation of the circuit block using the performance information;

(e) comparing a result of the simulation with the desired performance specification;

(f) if the desired performance specification is achieved, acting on the design so as to manufacture the semiconductor device;

(g) if the desired performance specification is not achieved, modifying an electronic component value of the circuit block and repeating the steps (d), (e) and (f).

The method may comprise a preliminary step of creating in the first library the design file. Each simulating arid modifying step may be performed manually after the creating step. Details of each simulating and modifying step may be stored in the design file. At each subsequent occasion when the design file is selected, the simulating and modifying steps may be performed automatically in accordance with the details stored in the design file.

Each design file may contain a process-independent layout of the circuit block, each process file may contain information about physical constraints of components produced by process, and the step (f) may include arranging the layout to meet the physical constraints. The information about the physical constraints may include minimum component spacing.

According to a second aspect of the invention, there is provided a computer program by a computer programme to perform a method according to the first aspect of the invention.

According to a third aspect of the invention, there is provided a computer program for programming a computer to perform a method according to the first aspect of the invention.

According to a fourth aspect of the invention, there is provided a medium containing a computer program according to the third aspect of the invention.

According to a fifth aspect of the invention, there is provided a semiconductor device made by a method according to the first aspect of the invention.

It is thus possible to provide a technique which allows semiconductor devices to be manufactured with a very high probability that a desired performance will be achieved in a single design procedure. By making use of manufacturing process information, the probability of making a device which fails to perform correctly when made by a particular manufacturing process can be greatly reduced. The design and manufacturing procedure can be made faster by making use of some knowledge-based artificial intelligence techniques based on storing and making available the results of previous design procedures. Thus, the time-to-market for new devices can be substantially reduced.

### BRIEF DESCRIPTION OF THE DRAWINGS

The invention will be further described, by way of example, with reference to the accompanying drawings, in which:

FIG. 1 is a flow diagram illustrating a method of manufacturing a semiconductor devise constituting an embodiment of the invention;

FIG. 2 is a block schematic diagram of a system for performing the method illustrated in FIG. 1.

FIG. 3 is a circuit diagram of a circuit block to which the method of FIG. 1 may be applied;

FIG. 4 illustrates a layout for the circuit block of FIG. 3 formed by the method of FIG. 1; and

FIG. 5 illustrates another circuit block and its layout formed by the method of FIG. 1 .

### DESCRIPTION OF THE PREFERRED EMBODIMENT

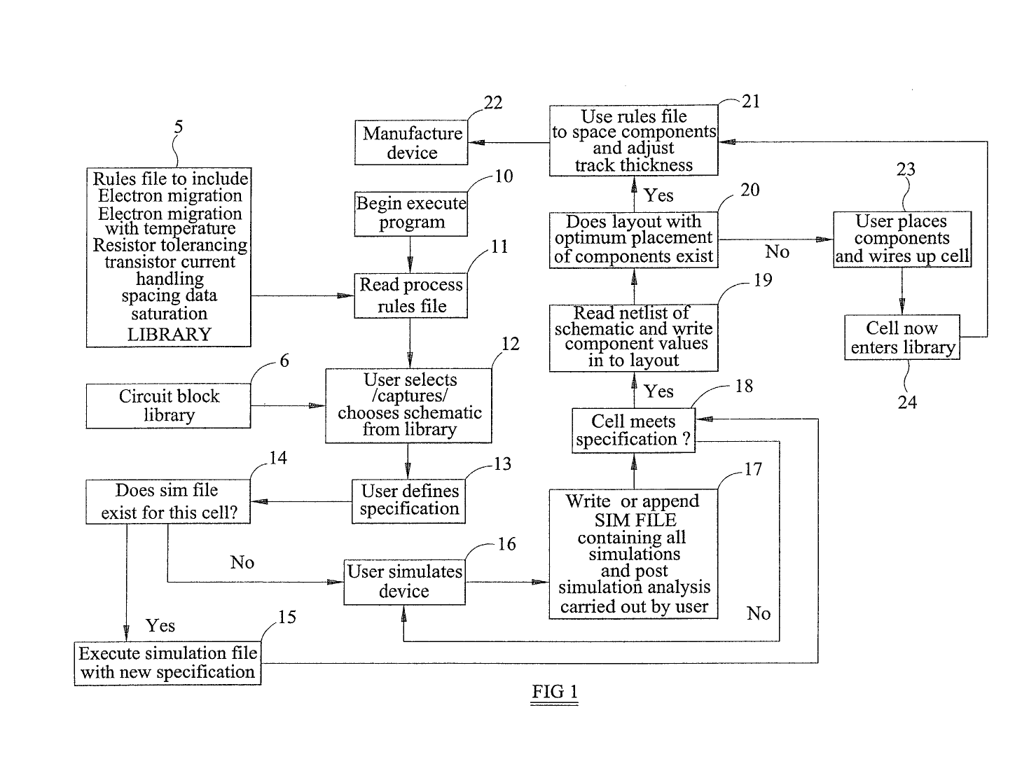

FIG. 1 illustrates a technique for manufacturing an integrated circuit based on new or existing circuit blocks. A technique for designing and manufacturing a single circuit block is illustrated but this may be repeated in order to form some or all of the circuit blocks making up a complete integrated circuit.

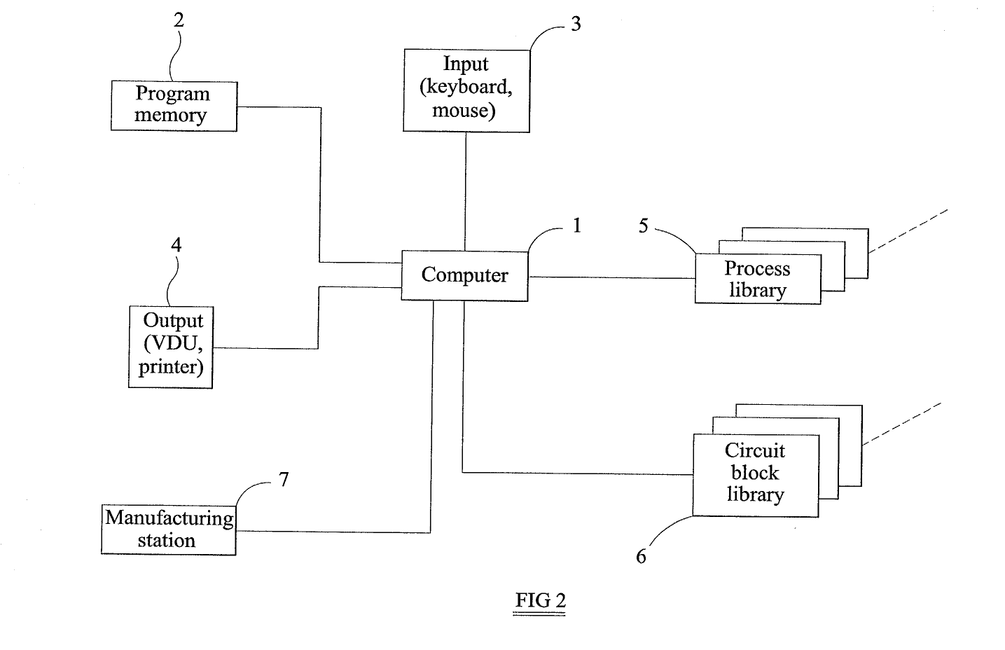

Many of the steps of this technique are performed by a computer 1 shown in FIG. 2 and provided with a program memory 2 containing a program for controlling operation of the computer 1. The computer 1 is also provided with inputting means 3, such as a keyboard and mouse, and output means 4, such as a visual display unit (VDU) and printer. A process library 5 and a circuit block library 6 are provided in non-volatile random access memory and the computer has an output which supplies a final layout design to a manufacturing station 7, which converts the final layout into the integrated circuit. The manufacturing station 7 may comprise various parts which may be disposed at different locations. For example, the station 7 may comprise means generating masks for use in a physically separate integrated circuit manufacturing plant.

Execution of the program begins at 10 and, at 11, the process rule file for the manufacturing process which is to be used is read from the process library 5. The library 5 contains a file for each manufacturing process which might be used. Apart from the different categories of processes, such as bipolar, CMOS, MESFET, complementary bipolar and BiCMOS technologies, the rules may vary within any particular technology for different individual processes, for example performed at different manufacturing plants. The library 5 contains a process file for each individual process having parameters which are unique to that process with at least one parameter being different from each other process.

At 12, the user selects a circuit block or schematic from the library 6. If the library 6 contains the design for the desired circuit block, then the user merely selects or chooses the appropriate design. If the library 6 does riot contain the appropriate design, then the user can create a new file by capturing the schematic circuit diagram. For example, the schematic may be input manually together with design information relating to the performance of the circuit block.

At 13, the user defines a specification in terms of the performance which the circuit block is required to achieve. For example, the user may specify minimum noise and distortion performances required of the circuit block. A step 14 checks whether a simulation for the circuit block or cell has previously been performed such that a simulation file already exists. If not, a manual simulation is performed at 16 and, at 17, the simulation file containing all simulations and post simulation analyses performed by the user is written or appended to the design file in the library 6.

If the step 14 determines that a simulation file already exists for the circuit block, a fresh simulation is performed automatically at 15. The details of all previous manual simulations are stored in the simulation file so that the system performs an automatic simulation by emulating the previous simulations. For example, a previous main simulation may have performed repeated individual simulations with the value of one or more components being changed in steps between each individual simulation to achieve a desired performance. The automatic simulation 15 emulates this and any other procedures performed during previous manual simulations. The system therefore operates as a knowledge-based expert system which acquires and uses knowledge so as to improve the automatic simulation performed in the step 15.

A step 18 tests whether the result of the simulation is that the cell or circuit block meets the required specification. If not, control returns to the step 16 such that the steps 16 and 17 are repeated until the specification is met. When the specification is met, a step 19 reads the net list of the schematic and writes the component values to a physical layout for the circuit block.

A step 20 determines whether a layout with optimum placement of components exists in the design file. If so, a step 21 uses the process rules to space the components, for example in accordance with the minimum permitted spacing for the process being used, and adjusts conductive track thicknesses to ensure that they are adequate for the currents to be passed. The final layout is then passed to the manufacturing step 22. If an optimum layout does not exist, the user places the components in the appropriate locations and wires up the components to form the circuit block layout at 23. The layout is entered in the circuit block library 5 at 24 and the steps 21 and 22 are then performed.

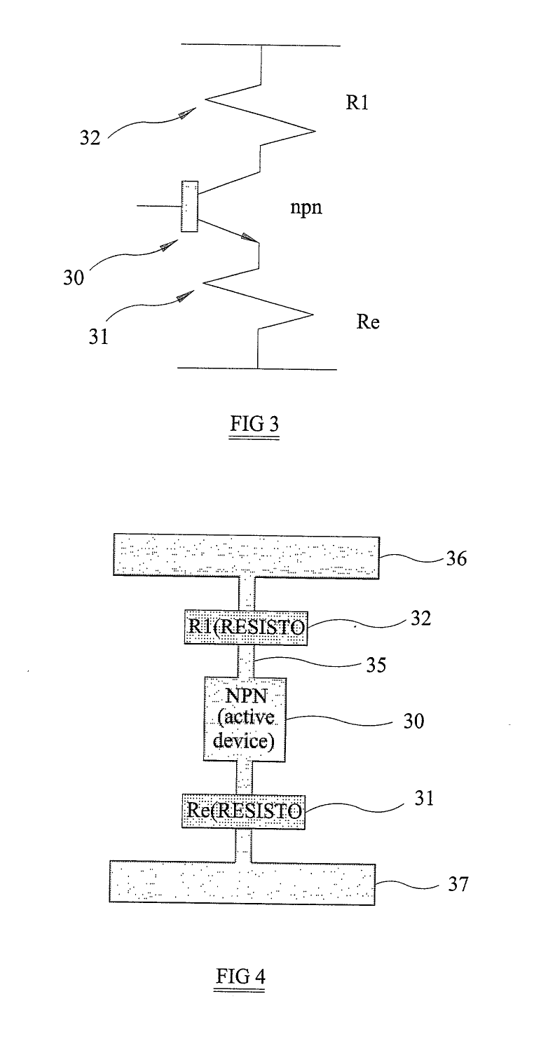

In order to illustrate the design procedure, a typical procedure for designing a common emitter amplifier circuit block as shown in FIG. 3 will be described. The circuit block comprises an npn transistor 30 with an emitter resistor 31 of value Re and collector load resistor 32 of value R1. In the step 11, a process rules file is read from the library 5 for a bipolar manufacturing process. The file contains data on electron migration, electron migration versus temperature, resistor tolerancing, transistor current handling, spacing data and transistor saturation performance. For example, the process file may contain definitions of minimum component spacing of 2.2 micrometres and M1 electron migration of 0.5 mA/μm. The process file may also contain any design equations are relevant to the particular process which has been chosen.

The step 12 then selects the design file for a common emitter amplifier of the type shown in FIG. 3. If no such file exists in the library 6, a file is created by the user entering the schematic circuit diagram shown in FIG. 3 together with design equations relevant to that particular circuit.

In this particular example, the highest achievable specification is stored in the design file.

At 13, the user defines the required performance specification, for example by indicating the required noise figure and distortion performance (for example in terms of IIP2 and IIP3). Operation of the circuit block is then simulated. As a first step in the simulation, the DC performance is considered so as to check the current flowing through the transistor 30. If the current is incorrect, adjustments may be made to the base bias conditions, the resistance values Re and R1, or the transistor geometry. The result of all simulations and analyses of direct current are written to the simulation file.

Once the DC conditions have been set, AC simulation begins. For example, the resistance value R1 may be adjusted in order for the common emitter stage to achieve the desired gain and this is also written into the simulation file.

The AC simulations continue with transient simulations in order to check the distortion performance. The distortion performances achieved in the simulation are again written into the simulation file (which forms part of the design file from the library 6). An example of a typical simulation file is as follows:

Cell: common emitter

Max spec:

GAIN=6

IIP3=130

IIP2=140

NF=4.5

Vcc=4.7

S11=−7

DC:

Re=20,ic=2 m

Re=25,ic=1.5 m

→Solution!

AC:

R1=65,gain=5.5

R1=70,gain=7.0

→Solution!

NF:

Re=25,Rf=200,NF=5.0

Re=25,Rf=220,NF=4.5

→Solution!

Transient:

Re=25,vbias=1.8,current=11.5 m,IIP3=129,IIP2=139

Re=25,vbias=1.9,current=2 m,IIP3=130,IIP2=140

→Solution.

The simulation adjusts the current by changing the value Re of the emitter resistor 31 and sets and adjusts the value R1 of the collect load resistor 32 to adjust the gain. The noise figure (NF) can be adjusted in order to achieve the specification by adjusting the value of the resistance Rf from the base of the transistor 30 to ground and the third order distortion IIP3 achieved by the circuit block is a function of the stage current.

If the simulation and checking fails to find a solution which allows the common emitter stage shown in FIG. 3 to achieve the desired performance specification in terms of tile noise figure and distortion performance, the user may intervene by means of the step 16 so as to try to achieve an acceptable performance by manually altering component values and then checking the results of further simulations. O

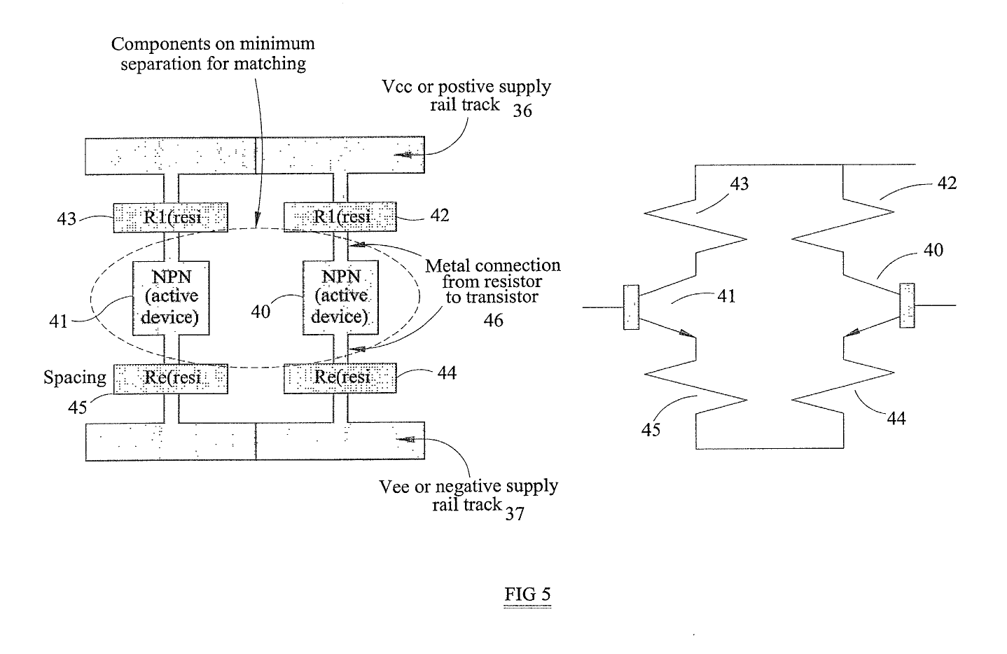

Once the circuit block design has been optimised so as to achieve the design performance specification, a suitable component layout is generated. If a layout already exists in the design file, then this is chosen and a suitable layout is illustrated in FIG. 4 for the common emitter stage of FIG. 3. The blocks 30-32 represent the layout shapes of the components 30-32 of FIG. 3 with interconnections between components being illustrated, for example at 35, and positive and negative supply lines being illustrated at 36 and 37, respectively.

If no layout exists in the design file, the user places the components manually and wires up the stage to achieve, for example, the layout shown in FIG. 4. This layout is stored in the design file.

Finally, the step 21 refers to the rules in the process file, such as the minimum component spacing, so as to ensure that the final layout complies with the constraints imposed by the particular manufacturing process.

During the simulation step 16, for example, the state of the transistor 30 is monitored to ensure that the transistor 30 operates continuously within an acceptable region. For example, the saturation performance of the transistor 30 is known from the process file. The operating point of the transistor 30 is monitored during each simulation and, if the transistor enters the saturation region of its characteristic, this is noted and may be signalled to the user. The simulation may then be repeated but with the biasing conditions and/or stage current modified such that the transistor does not saturate. If the performance specification cannot be met while preventing the transistor from saturating, this can be signalled to the user, who may then have the option of manual intervention in order to use experience of overcoming such problems.

As previously mentioned, the step 22 for manufacturing the device may be performed in any suitable way, such as by conventional techniques of forming masks and using thes in integrated circuit manufacturing processes.

These techniques may be applied to any circuit block and FIG. 5 illustrates the application to a long tail pair arrangement of npn transistors 40 and 41. The transistors 40 and 41 have collector load resistors 42 and 43 and emitter resistors 44 and 45, respectively. The metal connections from the resistors to the transistors are illustrated at 46 with the positive and negative supply rail tracks being illustrated at 36 and 37.

The long tail pair circuit block is designed or optimised using the same process described hereinbefore and the basic (process-independent) layout is retrieved at step 20 from the design file or is created by the user in the steps 23 and 24. However, an additional requirement is to minimise the separation of the individual components, particularly the separation between the resistors 42 and 43 the separation between the transistors 40 and 41 and the separation between the resistors 44 and 45, so as to maximise the matching of these pairs of components to optimise the performance of the long tail pair as a balanced or differential amplifying stage. The optimum layout therefore calls for the separations of these pairs of components to be minimised and the minimum component separation from the process file is used in the step 21 so as to ensure that the layout supplied to the step 22 achieves the maximum matching requirement while conforming with the minimum component spacing constraint of the manufacturing process.

1. A method of manufacturing a semiconductor device, comprising the steps of:
(a) selecting a design file containing a design of an analog circuit block from a first library;
(b) selecting from a second library a process file containing information about a manufacturing process including performance information about a performance of at least one electronic component in said circuit block;
(c) defining a desired performance specification to be achieved by said circuit block;
(d) simulating an operation of said circuit block using said performance information;
(e) comparing a result of said simulation with said desired performance specification;
(f) if said desired performance specification is achieved, acting on the design so as to manufacture said semiconductor device;
(g) if said desired performance specification is not achieved, modifying an electronic component value of said circuit block and repeating said steps (d), (e) and (f).

2. A method as claimed in claim 1, in which said step (g) is repeated until said desired performance specification is achieved.

3. A method as claimed in claim 1, comprising a preliminary step of creating in said first library said design file.

4. A method as claimed in claim 3, in which each of said simulating and modifying steps is performed manually after said creating step.

5. A method as claimed in claim 4, in which details of each of said simulating and modifying steps are stored in said design file.

6. A method as claimed in claim 5, in which, at each subsequent occasion when said design file is selected, said simulating and modifying steps are performed automatically in accordance with said details stored in said design file.

7. A method as claimed in claim 1, in which each said design file contains a process-independent layout of said circuit block, each said process file contains information about physical constraints of components produced by said process, and said step (f) includes arranging said layout to meet said physical constraints.

8. A method as claimed in claim 7, in which said information about said physical constraints includes a minimum component spacing.

9. A computer programmed by a computer program to perform a method as claimed in claim 1.

10. A computer readable storage medium including a computer program stored thereon, the computer program operable in connection with a computer to perform a method as claimed in claim 1.

11. A computer readable storage medium storing a computer program for performing the method of claim 1.

12. A semiconductor device made by a method as claimed in claim 1.
